(19) United States
(12) Patent Application Publication
(10) Pub. No.: US 2009/0003644 A1
(43) Pub. Date: Jan. 1, 2009

(54) ELECTROACOUSTIC TRANSDUCER

(76) Inventor: Masahito Furuya, Fuefuki-shi (JP)

Correspondence Address: BRINKS HOFER GILSON & LIONE, P.O. BOX 10395, CHICAGO, IL, 60610, US

(21) Appl. No.: 12/163,107

(22) Filed: Jun. 27, 2008

(30) Foreign Application Priority Data
Jun. 29, 2007 (JP) JP2007-171499

(51) Int. Cl. H04R 9/06

(52) U.S. Cl. 381/400

(57) ABSTRACT

An electroacoustic transducer includes a magnetic circuit unit that forms a magnetic gap, a voice coil inserted into the magnetic gap, and a diaphragm to which the voice coil is connected. The diaphragm has a central portion having an outer peripheral edge and an annular portion disposed underneath the central portion. The annular portion has an outer peripheral edge corresponding to the outer peripheral edge of the central portion, and an inner peripheral edge secured to the magnetic circuit unit. The diaphragm further has a joint portion formed at the outer peripheral edges of the central and annular portions, and the outer peripheral edges are joined together. The voice coil is disposed underneath the central portion of the diaphragm and joined to the joint portion.

### REFERENCE TO THE RELATED APPLICATIONS

This application claims priority under 35 U.S.C. § 119 to Japanese Patent Application No. JP2007-171499 filed on Jun. 29, 2007, the entire content of which is hereby incorporated by reference.

### BACKGROUND OF THE INVENTION

1. Technical Field of the Invention

The present invention relates to an electroacoustic transducer that may be incorporated into electronic devices such as mobile phones and personal digital assistants (PDAs) to inform the user of an incoming call by vibrating a diaphragm.

2. Description of the Related Arts

Conventionally, mobile communications devices such as mobile phones and PDAs are arranged to inform the user of an incoming call by selectively generating beep sound or melody sound, or vibrating the housing of the device instead of producing sound. Such an electroacoustic transducer is disclosed, for example, in Japanese Patent Application Publication No. 2003-143676. The electroacoustic transducer has, as shown in FIG. 10, a magnetic circuit unit including a cup-shaped yoke 22 and a combination of a circular columnar permanent magnet 24 and a top plate 25 that are successively stacked on the inner bottom surface of the yoke 22. A magnetic gap is formed between the inner peripheral surface of the yoke 22 and the outer peripheral surface of the top plate 25. A voice coil 27 disposed under the diaphragm 26 is inserted into the magnetic gap. The diaphragm 26 is a thin resin member having a central dome portion 26a and an annular portion 26b radially extended from an edge of the central dome portion 26a. The voice coil 27 is bonded to a flat boundary portion between the central dome portion 26a and the annular portion 26b. The peripheral edge of the annular portion 26b is laid on the upper end surface of a casing 23, and a retaining ring 28 is placed on the peripheral edge of the annular portion 26b. The casing 23 is covered at its upper side with a shallow dish-shaped protector 29 that is a thin metallic member bored with a plurality of sound release holes 29a. The protector 29 is bonded to the outer peripheral surface of the casing 23. The casing 23 is provided with a plurality of air vents 30. When supplied with a sound signal current, the voice coil 27 vibrates, and thus the diaphragm 26 vibrates to generate a sound or a voice.

Main factors that determine the characteristics of the electroacoustic transducer are as follows: Magnetic force B; diameter of a voice coil L; electric current I; mass of a vibration system Mo (mass of the vibration system including the voice coil, the diaphragm, the adhesive, etc.); stiffness So (indicating the degree of difficulty in movement of the diaphragm, which is determined mainly by the annular portion thereof); and diaphragm effective area Sd (area of the diaphragm used for sound generation). The sound pressure may be given by:

(Sound pressure)=A×B×L×I×Sd/(So×Mo)

where A is a variable characteristic of each individual speaker.

### SUMMARY OF THE INVENTION

With the structure of the electroacoustic transducer disclosed in Japanese Patent Application Publication No. 2003-143676, it is difficult to increase the sound pressure by enlarging the central dome portion of the diaphragm, which constitutes the main part of the diaphragm effective area.

It is an object of the present invention to provide an electroacoustic transducer that enables the central dome portion of the diaphragm to be effectively enlarged.

The present invention provides an electroacoustic transducer including a magnetic circuit unit that forms a magnetic gap, a voice coil inserted into the magnetic gap, and a diaphragm to which the voice coil is connected. The diaphragm has a central portion having an outer peripheral edge and an annular portion disposed underneath the central portion. The annular portion has an outer peripheral edge corresponding to the outer peripheral edge of the central portion, and an inner peripheral edge secured to the magnetic circuit unit. The diaphragm further has a joint portion formed at the outer peripheral edges of the central and annular portions, and the outer peripheral edges are joined together. The voice coil is disposed under the central portion of the diaphragm and joined to the joint portion.

In this electroacoustic transducer, the annular portion of the diaphragm is disposed underneath the central portion thereof. Therefore, the diaphragm effective area can be increased, and it becomes possible to obtain a high sound pressure.

Specifically, the central portion of the diaphragm may have an upwardly convex dome shape.

More specifically, the annular portion of the diaphragm may have an upwardly convex arcuate sectional configuration.

The electroacoustic transducer may be arranged as follows. The joint portion of the diaphragm has a tubular coil support extending coaxially with the voice coil, and the voice coil is mounted on the inner or outer peripheral surface of the coil support. With this arrangement, the installation of the voice coil is facilitated.

Specifically, the electroacoustic transducer may be arranged as follows. The coil support has an L-shaped sectional configuration having an annular support portion extending radially outward from the lower end edge of the coil support, and the voice coil is in contact with both the outer peripheral surface and the annular support portion of the coil support. With this arrangement, the installation of the voice coil is facilitated, and the voice coil can be reliably retained.

As another specific example, the voice coil may be formed by being wound on the outer peripheral surface of the coil support. With this arrangement, the formation and installation of the voice coil are further facilitated.

As still another specific example, the joint portion of the diaphragm may have an annular extension extending radially outward from the joint portion of the diaphragm. With this arrangement, the effective area of the diaphragm can be increased.

The annular portion of the diaphragm may be either impermeable or permeable to air. In a case where the annular portion of the diaphragm is permeable to air, the magnetic gap is filled with a liquid. This is done to block communication between the spaces outside and inside the diaphragm.

More specifically, the electroacoustic transducer may be arranged as follows. The magnetic circuit unit includes a yoke having a bottom wall portion and an annular peripheral wall portion extending upward from the peripheral edge of the bottom wall portion, and a combination of a magnet and a top plate that are successively stacked on the bottom wall portion of the yoke. The magnetic gap is formed between the peripheral edge surface of the top plate and the inner peripheral surface of the peripheral wall portion of the yoke. The bottom wall portion of the yoke has a through-hole formed at a position corresponding to the magnetic gap to communicate between the outside of the magnetic circuit unit and the inside of the yoke. This arrangement allows the voice coil to vibrate smoothly in the magnetic gap.

As another specific example, the electroacoustic transducer may be arranged as follows. The magnetic circuit unit includes a yoke having a bottom wall portion and a pair of peripheral wall portions extending upward from a pair of mutually opposing portions of the peripheral edge of the bottom wall portion, and a combination of a magnet and a top plate that are successively stacked on the bottom wall portion of the yoke. The magnetic gap is formed between the peripheral edge surface of the top plate and the inner peripheral surface of each of the peripheral wall portions of the yoke.

In this case, the bottom wall portion of the yoke may have a through-hole formed at a position corresponding to the magnetic gap to communicate between the outside of the magnetic circuit unit and the inside of the yoke.

Embodiments of the electroacoustic transducer according to the present invention will be explained below with reference to the accompanying drawings.

### BRIEF DESCRIPTION OF THE DRAWINGS

FIG. 1 is a sectional view of an electroacoustic transducer according to a first embodiment of the present invention.

FIG. 2 is a sectional view of an electroacoustic transducer according to a second embodiment of the present invention.

FIG. 3a is a plan view of an annular portion of a diaphragm shown in FIG. 2.

FIG. 3b is a sectional front view taken along the line 3b-3b in FIG. 3a, showing the annular portion of the diaphragm.

FIG. 4 is a sectional view of an electroacoustic transducer according to a third embodiment of the present invention.

FIG. 5 is a rear view of the electroacoustic transducer shown in FIG. 4.

FIG. 6 is a sectional view of an electroacoustic transducer according to a fourth embodiment of the present invention.

FIG. 7 is a sectional view of an electroacoustic transducer according to a fifth embodiment of the present invention.

FIGS. 8a, b and c are a plan view, a sectional front view, and a sectional side view of another magnetic circuit structure.

FIGS. 9a, b and c are a plan view, a sectional front view, and a sectional side view of still another magnetic circuit structure.

FIG. 10 is a sectional view of an electroacoustic transducer according to a prior art.

### DETAILED DESCRIPTION OF THE INVENTION

### First Embodiment

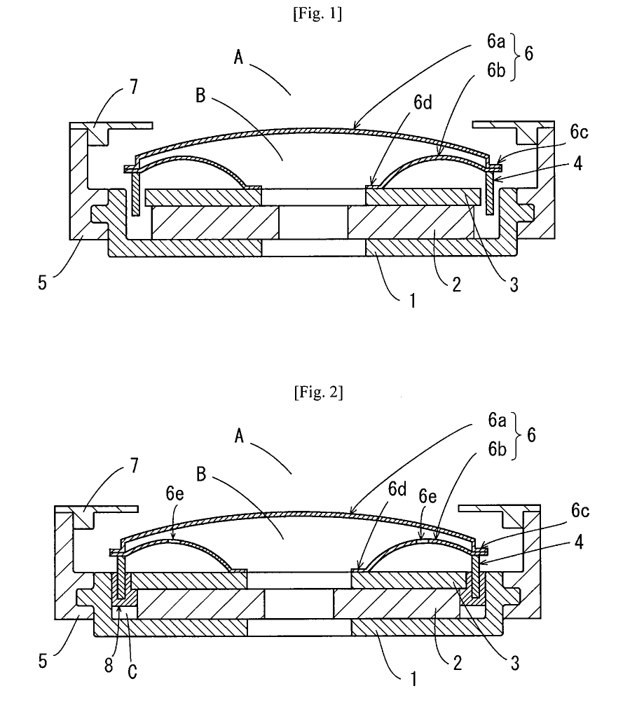

FIG. 1 is a sectional view of an electroacoustic transducer according to a first embodiment of the present invention. In FIG. 1, the electroacoustic transducer has a magnetic circuit unit including a cup-shaped yoke 1 and a combination of a disk-shaped magnet 2 and a flat plate-shaped top plate 3 that are successively stacked on the inner bottom surface of the yoke 1, in the same way as in the above-described prior art. The electroacoustic transducer further has a voice coil 4 inserted into a magnetic gap formed between the inner peripheral surface of the yoke 1 and the outer peripheral surface of the top plate 3. The yoke 1 is insert-molded in a resinous frame 5. A diaphragm 6 is made of a resin sheet, e.g. PEN (polyethylene naphthalate) or PET (polyethylene terephthalate), and has a dome-shaped central portion 6a and an annular portion 6b disposed underneath the central portion 6a. The outer peripheral edge of the central portion 6a and the outer peripheral edge of the annular portion 6b are joined together and form a joint portion 6c. The voice coil 4 is disposed under the diaphragm 6 and secured to the joint portion 6c. The inner peripheral edge 6d of the annular portion 6b is joined to the magnetic circuit unit. In the illustrated example, the inner peripheral edge 6d of the annular portion 6b is joined to an upper surface of the top plate 3, which constitutes the magnetic circuit unit, directly or indirectly through another component. A protector 7 is bonded to the upper end edge of the frame 5.

The inner peripheral edge 6d of the annular portion 6b is flexible and difficult to handle. Therefore, a metal ring or the like may be attached to the inner peripheral edge 6d of the annular portion 6b to make it easy to perform the assembling operation.

When used as a speaker, the electroacoustic transducer, in which the annular portion 6b of the diaphragm 6 is accommodated underneath the central portion 6a thereof, is housed in an enclosure, which is a casing of an electronic device. In this case, one of spaces A and B is communicated with the external space, and the other space A or B is communicated with the space in the enclosure. The spaces A and B are cut off from communication with each other. If not, sounds will cancel each other out, so that satisfactory performance cannot be obtained. Therefore, both the central and annular portions 6a and 6b of the diaphragm 6 are required to be impermeable to air.

In the electroacoustic transducer of this embodiment, the annular portion 6b of the diaphragm 6 is disposed underneath the central portion 6a thereof. Therefore, the central portion 6a can be enlarged, and hence the voice coil 4 can be enlarged. Consequently, the sound pressure can be increased. Further, positioning of the voice coil 4 is facilitated. In addition, because heat dissipation is facilitated, it becomes less likely that the voice coil 4 may become loose due to heat.

### Second Embodiment

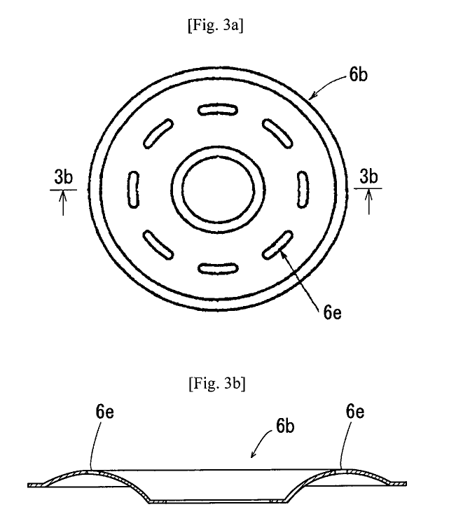

FIG. 2 shows an electroacoustic transducer according to a second embodiment of the present invention. FIGS. 3a and 3b are a plan view and a sectional view, respectively, showing the annular portion 6b of the diaphragm 6 of the electroacoustic transducer according to the second embodiment. The second embodiment differs from the first embodiment in that the annular portion 6b of the diaphragm 6 is provided with air holes 6e so as to be permeable to air. As a modification of this embodiment, the annular portion 6b may be made of an air-permeable material such as a mesh material. In this embodiment, the magnetic gap is filled with a liquid 8 (e.g. a magnetic fluid, or silicone oil), thereby blocking communication between the spaces A and B.

### Third Embodiment

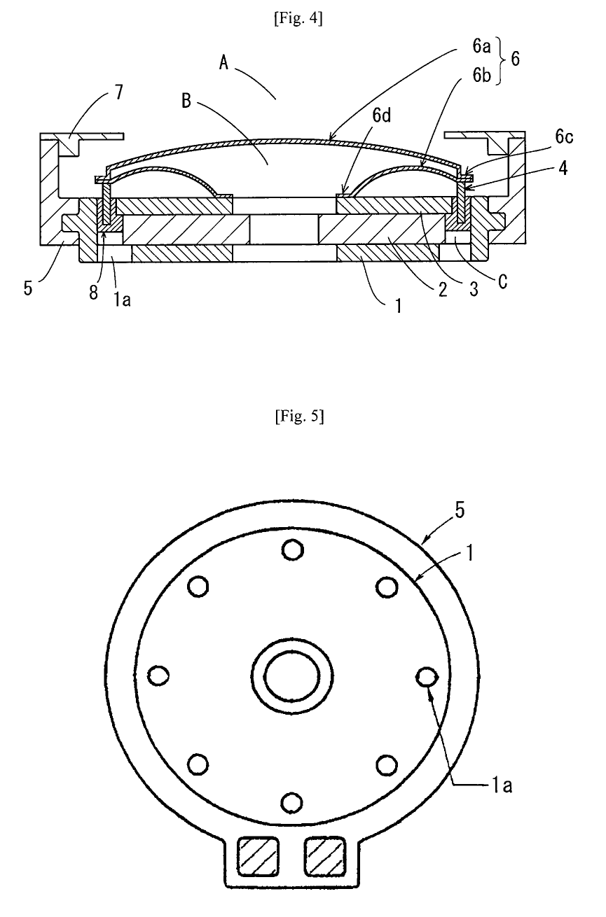

FIGS. 4 and 5 show an electroacoustic transducer according to a third embodiment of the present invention. This embodiment is substantially the same as the second embodiment. The third embodiment differs from the second embodiment in that air holes (through-holes) 1a are provided in the bottom of the yoke 1 at positions in an annular area corresponding to the magnetic gap. When the voice coil 4 is driven to vibrate with a large amplitude, the pressure in the space C varies to suppress the movement of the voice coil 4 undesirably. Therefore, it is preferable to provide air holes 1a in the bottom of the yoke 1 in the case of a speaker in which the voice coil 4 may vibrate with a large amplitude, although such air holes 1a are not necessary when there is no possibility of the voice coil 4 vibrating with a large amplitude.

### Fourth Embodiment

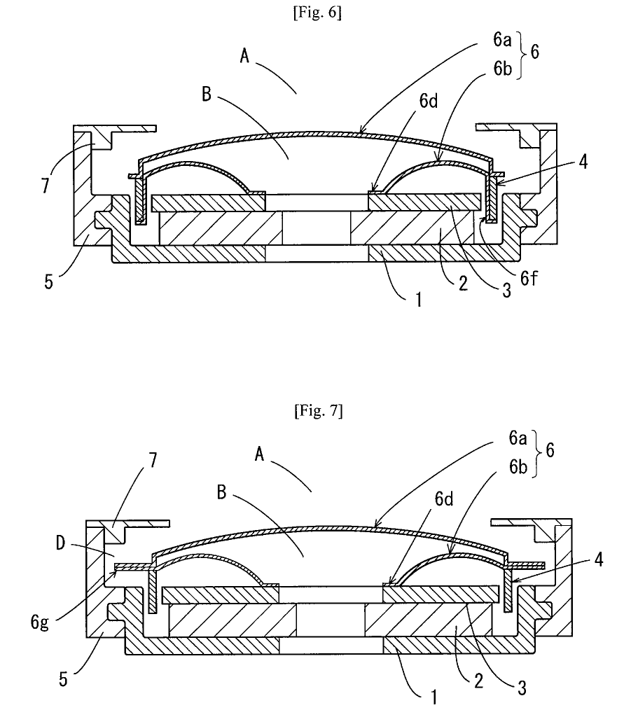

FIG. 6 shows an electroacoustic transducer according to a fourth embodiment of the present invention. This embodiment is substantially the same as the first embodiment. The fourth embodiment differs from the first embodiment in that a coil support 6f that supports the voice coil 4 is provided on the joint portion that joins together the respective outer peripheral edges of the central and the annular portions 6a and 6b of the diaphragm 6. The coil support 6f is formed in an L-shape as illustrated in the figure or in a U-shape in accordance with the height of the voice coil 4. Although in FIG. 6 the coil support 6f is provided on the annular portion 6b adjacent to the joint portion, it may be provided on the central portion 6a adjacent to the joint portion. It is also possible to wind a coil directly on the coil support 6f. This increases productivity. Further, it is possible to prevent the voice coil 4 from becoming loose due to heat by bonding the voice coil 4 to the coil support 6f formed in an L-shape.

### Fifth Embodiment

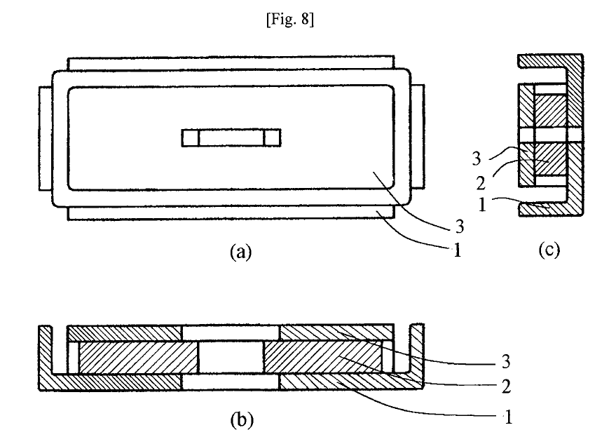

FIG. 7 shows an electroacoustic transducer according to a fifth embodiment of the present invention. This embodiment is substantially the same as the first embodiment. The fifth embodiment differs from the first embodiment in that the joint portion of the respective outer peripheral edges of the central and annular portions 6a and 6b of the diaphragm 6 has an annular extension 6g formed by extending either or both of the central portion 6a and annular portion 6b (both of them in FIG. 7) into a space D surrounded by an inner peripheral surface of the frame 5 and located outward of the side wall of the yoke 1. Because the outer shape of the central portion 6a can be further enlarged close to the outer shape of the product concerned, the effective area of the diaphragm 6 increases, and the sound pressure increases.

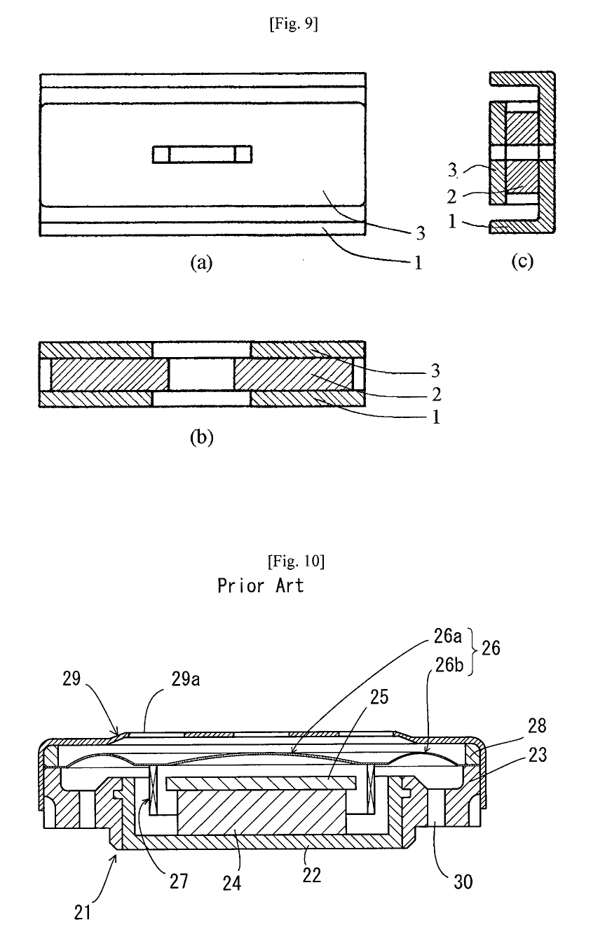

Although in the foregoing embodiments the present invention has been described with regard to a magnetic circuit that is substantially circular in plan view, the present invention is not necessarily limited to such a circular magnetic circuit. The magnetic circuit may be rectangular as a whole in plan view as shown in FIG. 8. In FIG. 8, the yoke 1 has two pairs of mutually facing peripheral walls extending from the mutually opposing long and short sides thereof. Alternatively, the magnetic circuit may be rectangular as a whole in plan view as shown in FIG. 9. In FIG. 9, the yoke 1 has a pair of mutually facing peripheral walls extending from the mutually opposing long sides thereof. In the magnetic circuit shown in FIG. 8, the voice coil associated therewith is formed in a rectangular shape. In the magnetic circuit of FIG. 9, the voice coil is formed in a rectangular or oval shape.

What is claimed is:

1. An electroacoustic transducer comprising:
a magnetic circuit unit that forms a magnetic gap;
a voice coil inserted into the magnetic gap; and
a diaphragm to which the voice coil is connected;
the diaphragm having:
a central portion having an outer peripheral edge;
an annular portion disposed underneath the central portion, the annular portion having an outer peripheral edge corresponding to the outer peripheral edge of the central portion and an inner peripheral edge secured to the magnetic circuit unit; and
a joint portion formed at the outer peripheral edge of the central portion and the outer peripheral edge of the annular portion and the respective outer peripheral edges of the central portion and the annular portion being joined together;
the voice coil being disposed under the central portion of the diaphragm and joined to the joint portion.

2. The electroacoustic transducer of claim 1, wherein the central portion of the diaphragm has an upwardly convex dome shape.

3. The electroacoustic transducer of claim 2, wherein the annular portion of the diaphragm has an upwardly convex arcuate sectional configuration.

4. The electroacoustic transducer of claim 1, wherein the joint portion of the diaphragm has a tubular coil support extending coaxially with the voice coil, the voice coil being mounted on one of inner and outer peripheral surfaces of the coil support.

5. The electroacoustic transducer of claim 2, wherein the joint portion of the diaphragm has a tubular coil support extending coaxially with the voice coil, the voice coil being mounted on one of inner and outer peripheral surfaces of the coil support.

6. The electroacoustic transducer of claim 3, wherein the joint portion of the diaphragm has a tubular coil support extending coaxially with the voice coil, the voice coil being mounted on one of inner and outer peripheral surfaces of the coil support.

7. The electroacoustic transducer of claim 4, wherein the coil support has an L-shaped sectional configuration having an annular support portion extending radially outward from a lower end edge of the coil support, the voice coil being in contact with both the outer peripheral surface and the annular support portion of the coil support

8. The electroacoustic transducer of claim 5, wherein the coil support has an L-shaped sectional configuration having an annular support portion extending radially outward from a lower end edge of the coil support, the voice coil being in contact with both the outer peripheral surface and the annular support portion of the coil support.

9. The electroacoustic transducer of claim 6, wherein the coil support has an L-shaped sectional configuration having an annular support portion extending radially outward from a lower end edge of the coil support, the voice coil being in contact with both the outer peripheral surface and the annular support portion of the coil support.

10. The electroacoustic transducer of claim 4, wherein the voice coil is formed by being wound on the outer peripheral surface of the coil support.

11. The electroacoustic transducer of claim 5, wherein the voice coil is formed by being wound on the outer peripheral surface of the coil support.

12. The electroacoustic transducer of claim 6, wherein the voice coil is formed by being wound on the outer peripheral surface of the coil support.

13. The electroacoustic transducer of claim 1, wherein the joint portion of the diaphragm has an annular extension extending radially outward from the joint portion of the diaphragm.

14. The electroacoustic transducer of claim 2, wherein the joint portion of the diaphragm has an annular extension extending radially outward from the joint portion of the diaphragm.

15. The electroacoustic transducer of claim 3, wherein the joint portion of the diaphragm has an annular extension extending radially outward from the joint portion of the diaphragm.

16. The electroacoustic transducer of claim 1, wherein the annular portion of the diaphragm is impermeable to air.

17. The electroacoustic transducer of claim 1, wherein the annular portion of the diaphragm is permeable to air, and the magnetic gap is filled with a liquid.

18. The electroacoustic transducer of claim 17, wherein the magnetic circuit unit includes:
a yoke having a bottom wall portion and an annular peripheral wall portion extending upward from a peripheral edge of the bottom wall portion; and
a combination of a magnet and a top plate that are successively stacked on the bottom wall portion of the yoke;
the magnetic gap being formed between a peripheral edge surface of the top plate and an inner peripheral surface of the peripheral wall portion of the yoke;
the bottom wall portion of the yoke having a through-hole formed at a position corresponding to the magnetic gap to communicate between an outside of the magnetic circuit unit and an inside of the yoke.

19. The electroacoustic transducer of claim 16, wherein the magnetic circuit unit includes:
a yoke having a bottom wall portion and a pair of peripheral wall portions extending upward from a pair of mutually opposing portions of a peripheral edge of the bottom wall portion; and
a combination of a magnet and a top plate that are successively stacked on the bottom wall portion of the yoke;
the magnetic gap being formed between a peripheral edge surface of the top plate and an inner peripheral surface of each of the peripheral wall portions of the yoke.

20. The electroacoustic transducer of claim 17, wherein the magnetic circuit unit includes:
a yoke having a bottom wall portion and a pair of peripheral wall portions extending upward from a pair of mutually opposing portions of a peripheral edge of the bottom wall portion; and
a combination of a magnet and a top plate that are successively stacked on the bottom wall portion of the yoke;
the magnetic gap being formed between a peripheral edge surface of the top plate and an inner peripheral surface of each of the peripheral wall portions of the yoke;
the bottom wall portion of the yoke having a through-hole formed at a position corresponding to the magnetic gap to communicate between an outside of the magnetic circuit unit and an inside of the yoke.
